(19) United States
(12) Patent Application Publication
(10) Pub. No.: US 2004/0138943 A1
(43) Pub. Date: Jul. 15, 2004

(54) System and method of tracking, assessing, and reporting potential purchasing interest generated via marketing and sales efforts on the internet

(76) Inventor: Brian Silvernail, Wyoming, MI (US)

Correspondence Address: BRIAN D. SILVERNAIL, 169 MONROE AVE., STE. 200, GRAND RAPIDS, MI, 49503, US

(21) Appl. No.: 10/684,418

(22) Filed: Oct. 15, 2003

Related U.S. Application Data
(60) Provisional application No. 60/418,289, filed on Oct. 15, 2002.

(51) Int. Cl. G06F 17/60

(52) U.S. Cl. 705/10

(57) ABSTRACT

The present invention is a system and method that tracks, accounts for, and assesses consumer interest and response to internet marketing and sales efforts. This system and method allows items offered for sale to the purchasing public via the internet to be tracked in terms of assessing the quantum of interest expressed by the potential purchaser in response to the internet marketing efforts pertaining to the sale of these items. The invention also offers and provides a broadcasting feature by which to market specific items. The invention is intended to provide a paperless marketing system and subsequent tracking of marketing results in real time. In addition, the system is intended to easily convert direct person-to-person responses generated from all forms of advertising (i.e.—signage, print, radio, television, etc.) into digitally recorded information that is used to enhance a seller's awareness of the results of an overall marketing campaign relating to an item offered for sale to the purchasing public. Finally, the system offers a means to generate a customized multimedia presentation for a single item for sale. Given present computer technology, specifically in terms of capacity to gather and deliver digital information in a convenient, timely, and cost effective manner, the present invention is best applied to the sale of unique, complex, and/or high (dollar) value items offered via the internet. Examples of items offered for sale via the internet may include, but are not limited to: real estate, capital equipment, heavy machinery, commercial or passenger vehicles, recreational vehicles, watercraft, and aircraft. However, as new technology emerges, evolves, and becomes more readily accessible, the present invention will be suitably applied to a vast array of less complex and/or lower (dollar) value items. Such less complex and/or lower (dollar) value items include, but are not limited to, music (in any recorded format), artwork, household items (furniture, jewelry, electronics, appliances, books, etc.), and commercial items (equipment, supplies, etc.). All features of the system and method are contained in web services modules using web-based programming technology. The web service modules also allow customized interface to existing or planned database-driven web sites operated by sellers, seller's agents, and internet service providers, who intend to meet the next level of customer demands for any given industry or application. In addition, the web services format is suited to being subsequently sold either by franchise, by license or by fee for services to outside parties in applicable industries.

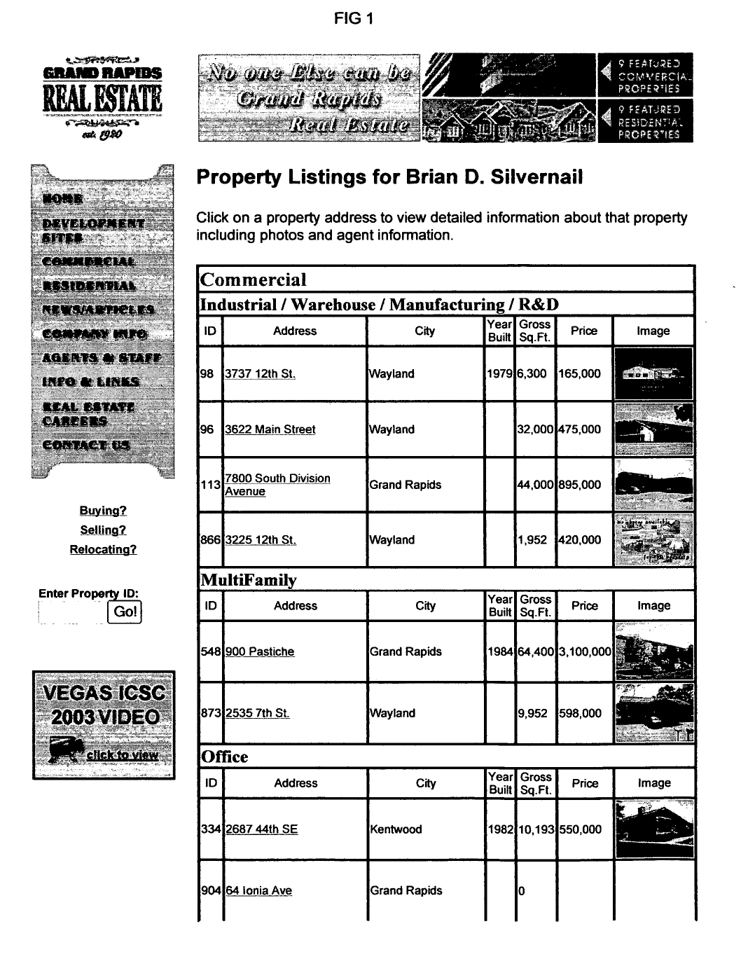

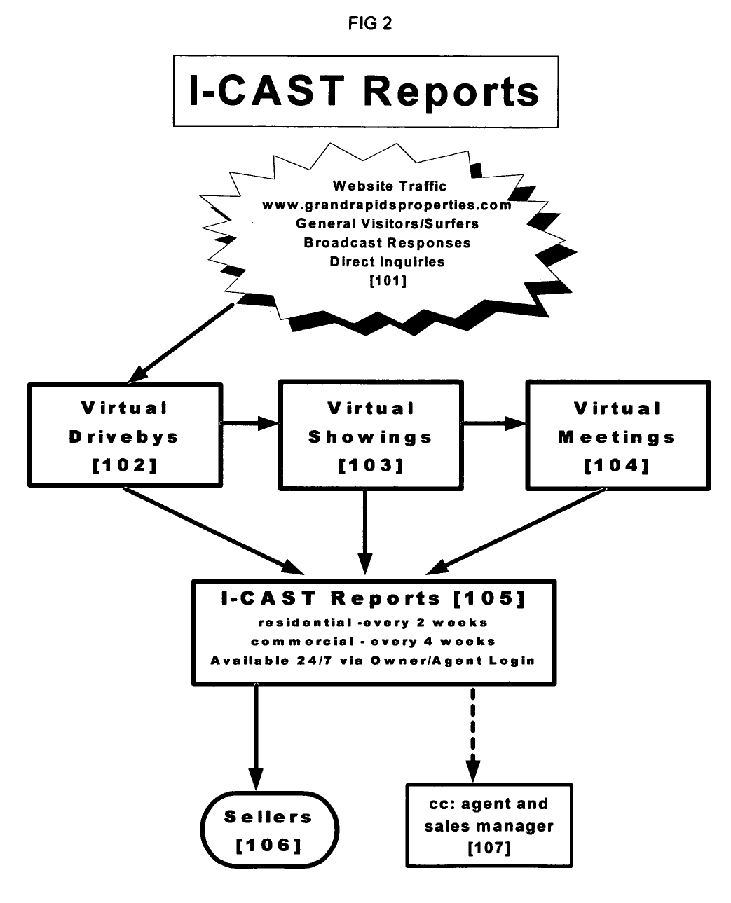

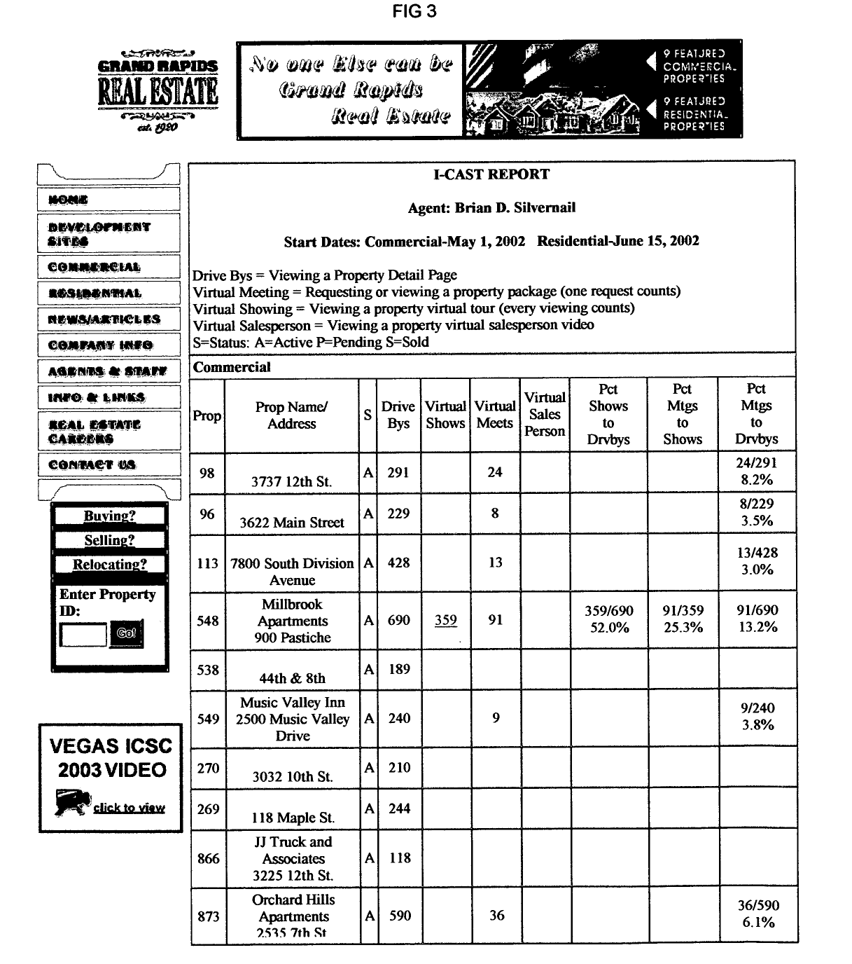

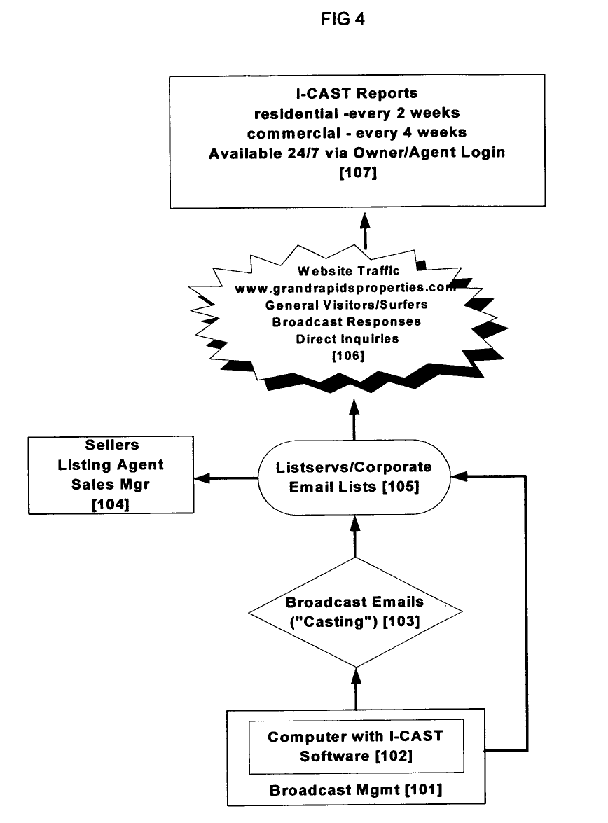

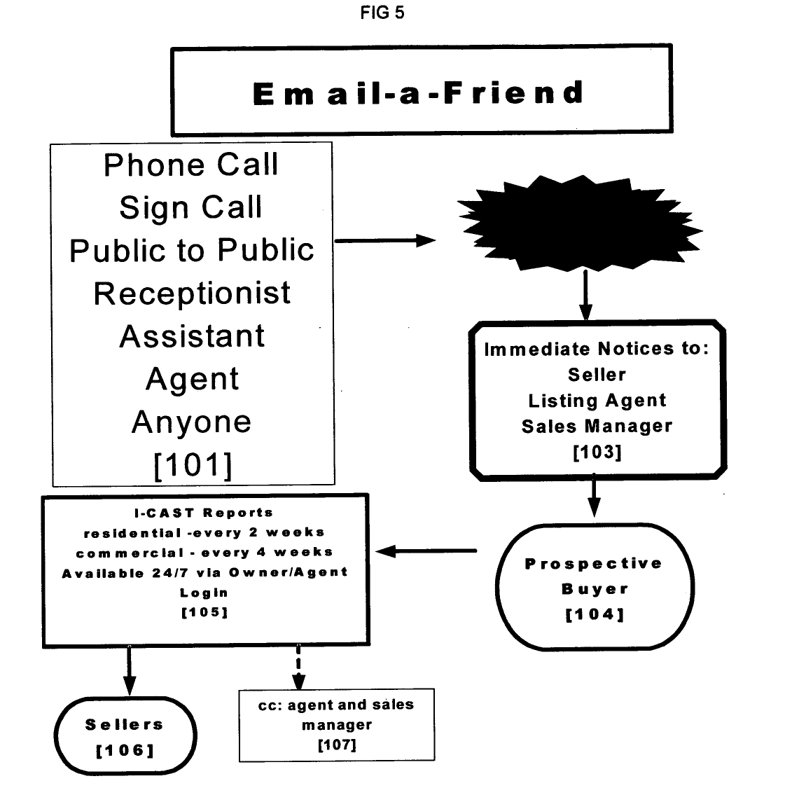

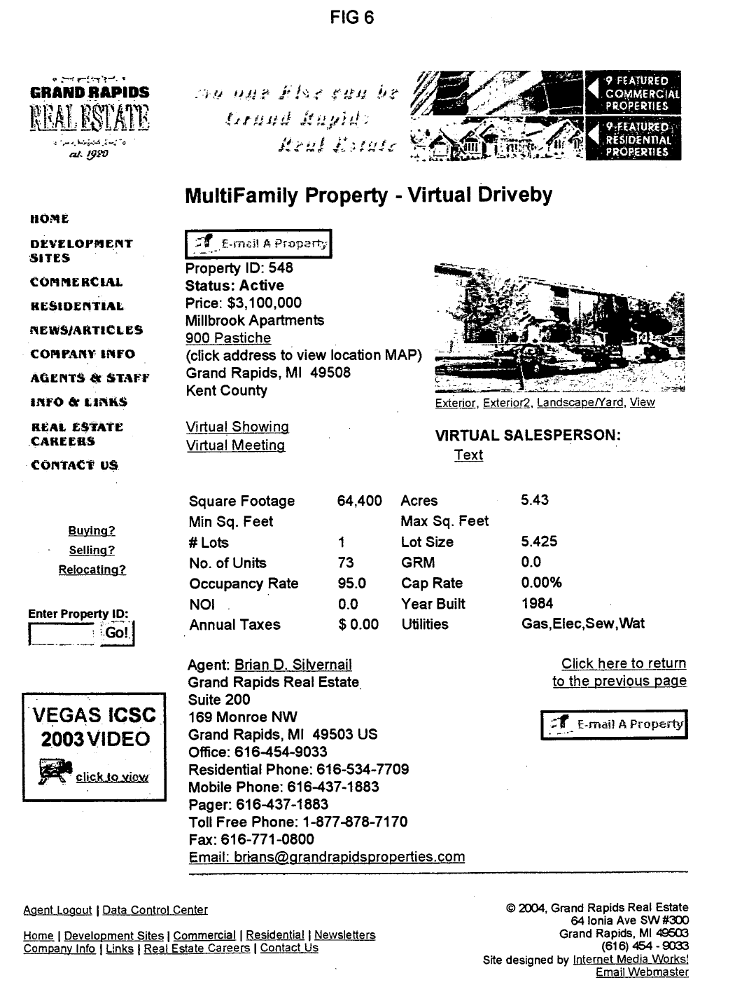

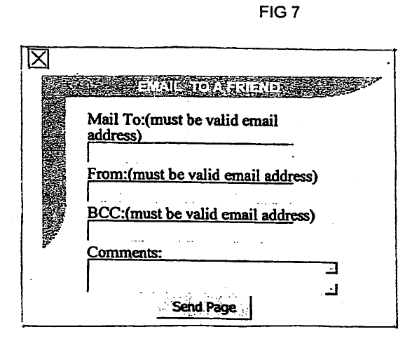

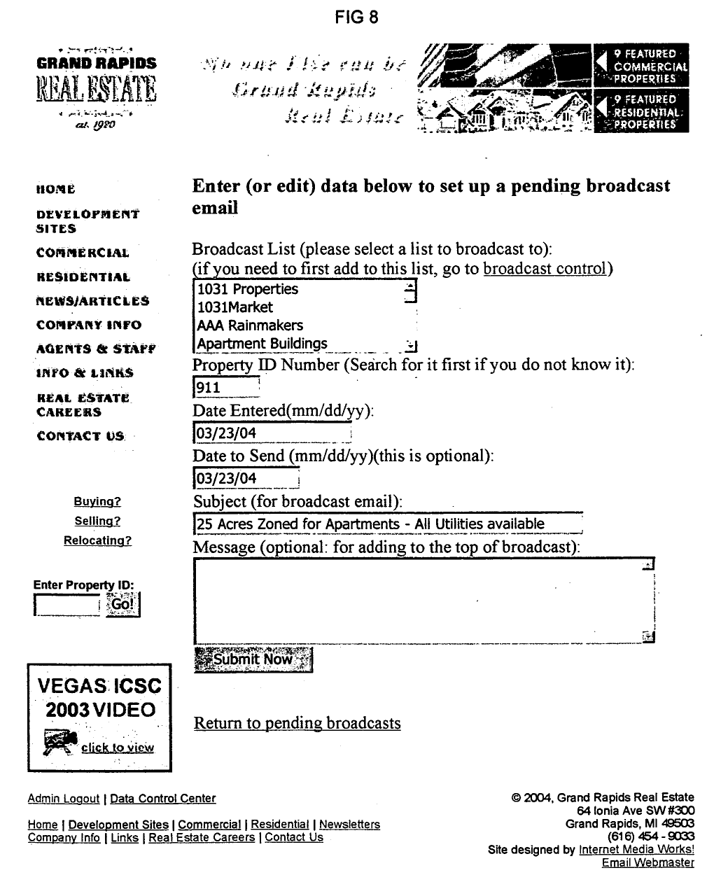

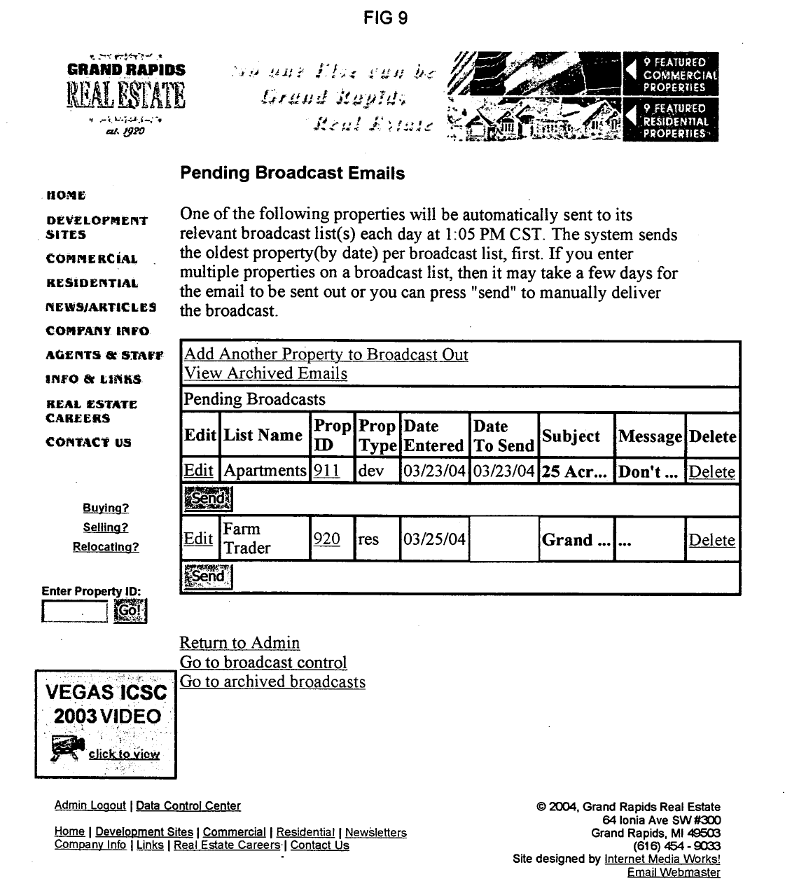

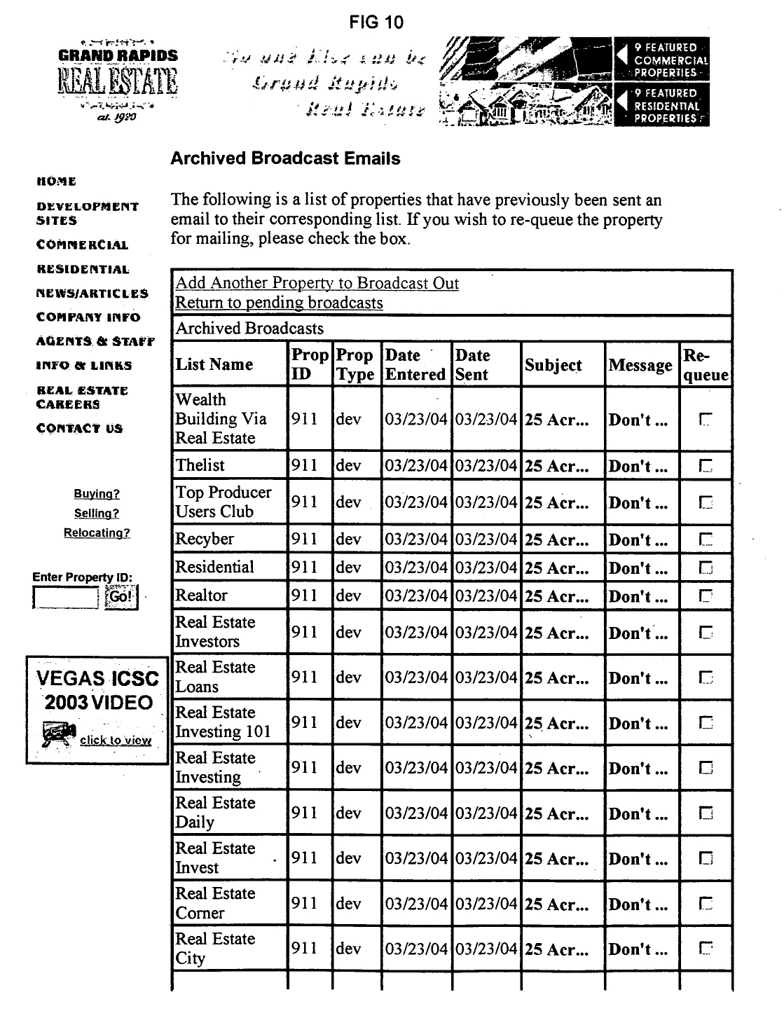

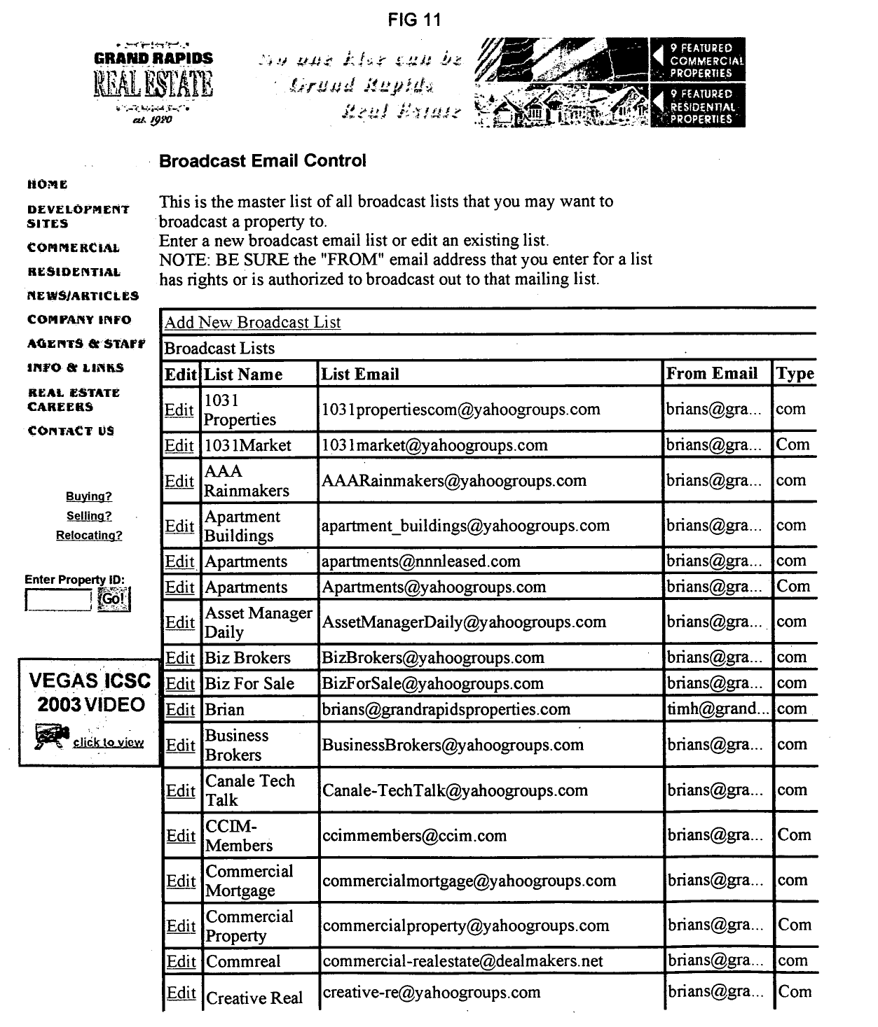

### BACKGROUND OF THE INVENTION

The system and method was conceived in the context of real estate sales. A typical real estate transaction involves the owner of a real property hiring a real estate agent to represent his/her interests pertaining to the transfer of the property. One of the key roles of this agent is to market the seller's property in a way that exposes the property to as many ready, willing and able buyers as possible.

A common problem associated with real estate sales is that it is difficult for a seller to gauge how sufficient, appropriate, or effective the agent's marketing efforts are. The seller has few means of knowing the amount and/or level of interest generated for the property other than through whatever feedback information the agent provides. Essentially, the seller acts on faith; assumes that a maximum reasonable effort is being made by the agent to market the property; and presumes that the seller is being filly informed about any interest expressed by prospective buyers [hereon referred to as “prospect(s)”] with regard to the property. Unfortunately, these assumptions are not always true.

In practical terms, it is virtually impossible for an agent to complete these efforts through normal means. At the very least, it would not be cost effective to provide countless individual messages in real time via personal acknowledgement from a real estate agent (or from the numerous sales assistants that would likely be required).

Ideally, the seller would have access to detailed reports of all marketing activities associated with the property. A fully informed seller could then be confident that he/she is “getting what he/she paid for”, along with receiving the best possible price for the property.

It is imperative to note that the present invention is applicable to the sale of a vast array of items. However, due to the current evolutionary state of computer technology (as of October 2002), the present invention is best suited to items that are not only unique in nature, but also of high monetary value. Current technology, specifically that which is both affordable and easily accessible to the general public, does not facilitate low enough transaction costs to justify applying the system to the sale of low (dollar) value items.

Technological capabilities affect transaction costs by determining how costly, timely, and efficiently digital information may be created, manipulated, utilized, and distributed. However, as digital data input, processing, and delivery capabilities expand, associated transaction costs will diminish to the point that it is feasible to apply the system/process to virtually any item for sale.

One of the most valuable and important characteristics of the invention is the ability to showcase a unique and/or one-of-a-kind item over the internet. Particularly, the invention displays an item in such a way that one may examine the intricacies, peculiarities, and exclusive features of the subject item in a thorough manner, highly similar to how one could if the item were physically present. The invention is especially valuable for the sale of used items that, due to aging, wear, or modification, often tend to have unique qualities not present on their new, unutilized counterparts.

The I-CAST system, process, method is well suited to be incorporated into a service that enables a person acting in a “For Sale By Owner” capacity to effectively create a professional quality marketing campaign/presentation solely for one particular item. Ultimately, the seller will be able to use the I-CAST system, for a fee, to personally create an interactive digital presentation, or “commercial”, showcasing a single item. The system will utilize an easy-to-use, tutorial, template format, in which the user is guided through an information gathering process on computer, in order to create a customized multimedia presentation. Again, technology is the key factor determining what types of items, in terms of complexity (of the item or the associated transaction) and value (generally monetary), are feasible to sell in this manner. As mentioned previously, the stable of items that the I-CAST system/process may practically and profitably apply to will progressively increase as new technological innovations develop.

The present invention facilitates a service offering the following benefits to an individual selling an item in a “For Sale By Owner” capacity:

1. Media Production—the present invention allows a user to insert information regarding a particular item into a series of template screens. In order for the system to create the customized media presentation for the subject item, the system will prompt the user to input various forms of information. Example categories of information that may be incorporated into the presentation include, but are not limited to, contact information, biographies, background narratives, a text and/or audio or video “sales pitch”, and all manners of audio/visual material available (merely limited by technological capacity at the time of production) pertaining to the subject item. Information input into the templates may derive from two possible sources:

a. Self-produced—the seller may input information personally by typing text into various fields on a computer screen as prompted by the system. Additionally, the system will prompt the user to input audio and visual information by downloading the data to the system via a specified format or source (i.e.—from a compact disk, DVD, floppy disk, digital camera or video recorder, etc.).

b. Production services—an entity, one that offers media production services that incorporate the I-CAST system, may produce any or all necessary or desired audio/visual presentation material on behalf of the seller of an item, for a fee. The seller may then personally input this material into the system via the template screens or may pay an additional fee to have the media production service generate the entire multimedia presentation.

2. Marketing/Distribution—the present invention allows the seller to inexpensively create exposure for an item for sale by digitally marketing and distributing the item. All forms of non-digital marketing may be used to direct prospective buyers to a website that displays the multimedia presentation for the item for sale. The presentation material may also be distributed via the “Broadcast Function” described herein.

3. Accountability—the present invention provides feedback to the seller regarding buyer interest and activity associated with the subject item. This allows the seller to adjust key marketing variables (i.e.—product, price, promotion, distribution) to achieve improved and/or desired results.

The present method or system offers a highly effective means for the creators of unique items, such as musicians or artists, to showcase and sell their work directly via the internet. Most significantly, this may eliminate the necessity or requirement of a third party to reproduce, market, and distribute such unique items. The rising capabilities and declining costs of technology make it increasingly feasible for artists and musicians to record (music), reproduce (both art and music), and distribute their work on their own. Specifically, this is due to the increasing availability of inexpensive, high quality, digital audio and video recording devices and recording media, computer processors, and color printing devices. Artists and musicians will be able to distribute their own work via a personal website that incorporates the I-CAST system and its associated presentation material. Such unique items could be sold via the internet by offering the items on a fee per download basis.

Lastly, the present invention facilitates a new concept and opportunity in the realm of real estate investment. Particularly, the I-CAST system or method allows for the creaton of an entirely unique form of income property. The income property format is based on a consignment sales concept. Be it an indoor or outdoor sales venue, the property is divided into numbered spaces (i.e.—parking spaces/stalls, bins, storage spaces, shelving units, etc.) on or in which items for sale are placed. Each item for sale has an identification number assigned to it in accordance with the numbered storage location. Sellers would place items on the property for a contingency fee based on actual sale price. In return for the percentage fee, the property owner provides a high visibility location and the marketing benefits of the I-CAST system. The I-CAST process is incorporated into the sales process via a computer kiosk format. Computer terminals on the property allow prospective purchasers to preview items for sale in detail on an internet website featuring the I-CAST system. The benefits of the I-CAST based consignment lot format include:

quick, easy access to information on inventory, including its location on the site

constant, real time viewing access of inventory from any location

all associated marketing benefits for the seller, such as the ability to create personalized multimedia presentations (likely using a tutorial template format) and the ability to gauge associated interest in the item

### BRIEF SUMMARY OF THE INVENTION

The present system is known as the Internet Casting Accounting Sales Technology or the “I-CASr” system or method. The I-CAST system and method comprises three main features that offer major benefits to sellers and/or buyers of unique items (currently limited to complex, and/or high (dollar) value items such as real estate). It also benefits the agents of such transactions (such as real estate sales) in multiple ways.

The “Casting” feature of the invention allows sellers to create more market exposure for the item, thus increasing the likelihood of selling the item quickly and at the desired price. The “Casting” feature allows agents to create more market exposure for the item, thus raising their ability to attract more property listings, sell properties in a shorter timeframe, and increase their income potential. Furthermore, the “Casting” feature gives buyers an increased access to market offerings.

The “Accountability” feature keeps sellers highly informed about marketing activities associated with the item for sale. This feature creates detailed reports, called “I-CAST Reports”, showing the quality and quantity of prospective buyer interest in the item, based on a three-tiered ranking system. These reports also generate statistical information associated with prospective buyer activity in a clear and understandable manner. The “Accountability” feature thus benefits the agent by generating an automatic written report of marketing activity associated with an item being offered for sale; and provides information concerning the subsequent consequences and results of such marketing activity. These reports also constitute both evidence and cogent proof that the property was shown in accordance with the terms of the agent's contract. Thus, the agent is able to effectively service a greater number of property listings as well as to offer better overall service to all clients.

The “Presentation Feature” of the system offers the ability to create a customized multimedia (text, audio, visual) presentation of an item for sale. The presentation information thus generated is categorized and manipulated according to the tiered levels associated with the “Accountability” feature of the system.

### BRIEF DESCRIPTION OF DRAWINGS

Drawing 01/11 shows an example of an Inventory List for an I-CAST suitable Real Estate website.

Drawing 02/11 depicts the inputs and outputs for the I-CAST Reporting Function. Website Traffic (101) generates activities that are categorized by tiered “levels of interest” Virt Drive-Bys (102), Virtual Showings (103), and Virtual Meetings (104). Website Traffic (101) will generally follow the path of Virtual Drive-By (102) to Virtual Showing (103) to Virtual Meeting (104), but may progress directly from Virtual Drive-By (102) to Virtual Meeting (104). Activity at all levels (102, 103, 104) is recorded and reported in I-CAST Reports (105). I-CAST Reports (105) are sent to Sellers (106) and Agent(s) and Sales Managers (107).

Drawing 03/11 shows an example of the “I-CAST Report”, as it pertains to the Real Estate industry.

Drawing 04/11 depicts the Broadcasting, or “Casting”, Function of I-CAST. Broadcast Management activities (101) are performed on web based server using I-CAST modules (102), to determine appropriate items to be broadcast, along with maintaining Listservs/Corporate Email Lists (105). The web based I-CAST module (102) automatically sends information on sale items via Broadcast Email (103) to Listservs/Corporate Email Lists (105), along with sending a Notice to Seller, Listing Agent, and Sales Manager (104) that a Broadcast Email (103) occurred. These activities generate Website Traffic (106) that is recorded and reported in I-CAST Reports (107).

Drawing 05/11 shows a diagram of the “Email-A-Friend” or, depending on the industry, the “Email-This-Property” or “Email-This-Item” feature of I-CAST. The source user (101) initiates the “Email-A-Friend” feature (102), thereby sending a web page to the prospective buyer (104), along with an immediate email notice (103) to the Seller, Listing Agent, and Sales Manager. Once the prospective buyer clicks on the page, or interacts with the website, buyer activity is recorded and reported via I-CAST Reports (105). I-CAST Reports (105) are sent to Sellers (106) and Agent(s) and Sales Managers (107).

Drawing 06/11 shows the placement of the “Email-A-Friend” button on a sale item's web page.

Drawing 07/11 shows the “pop up window” for the “Email-A-Friend” feature.

Drawing 08/11 shows an example of the “Input Item/Choose Broadcast List” screen.

Drawing 09/11 shows an example of the “Pending Broadcast Email List” screen.

Drawing 10/11 shows an example of the “Historical Broadcast Email Archive” screen.

Drawing 11/11 shows an example of the “Broadcast Email Contror” screen

### DETAILED DESCRIPTION OF THE INVENTION

The present invention, called “Internet Casting Accountability Sales Technology” and also referred to by the acronym “I-CAST”, comprises both a process for categorizing, manipulating, and distributing presentation material for an item for sale, in addition to including a set of web based programmed functions and manipulative steps that are preferably used as an adjunct or overlay to an existing Internet website. The web based programmed features and manipulative steps are ideally suited to most existing websites featuring comprehensive information on unique (due to technological limitations at present, mainly complex, and/or high (dollar) value) items that are being offered for sale to the purchasing public via the internet. Though technology will eventually permit the profitable application of the system to nearly all unique items for sale, the system is currently (as of October 2002) best suited to such items that require:

1. Extensive and/or detailed documentation or visual impressions of the item in order for a potential buyer to give it further consideration or to make a purchase decision.

2. Accountability to the seller by those persons (typically agents) marketing the item on behalf of the seller.

Illustrative items of such a unique, or complex, or expensive nature include, but are not limited to: real estate, capital equipment, heavy machinery, commercial or passenger vehicles, recreational vehicles, watercraft, and aircraft. Many other examples of such items are also commonly known.

All the features and component manipulations comprising the system and method are contained and included in web based modules using web-based technology. The software package further comprises a template that can be customized to meet the requirements and demands of a given industry or application The web services format is also suited to being sold under franchise or license or fee for services to any other person in the applicable industries.

The Inventory Listing Component:

An existing or planned website suitable for using the I-CAST system should contain a database-driven list, or inventory, of all items being offered for sale that are available at said website. The full inventory listing included on the website may be divided into subcategories as deemed appropriate. All the items identified on the inventory list should feature a selectable hypertext link(s) in order to allow visitors and potential purchasers easy access to additional information about the item of interest.

Each inventory item should feature an associated web page(s) that displays all detailed descriptions and associated documents or visual impressions available, or deemed appropriate, to aid in the sale of said item.

The Presentation Function Component:

The Presentation Function categorizes presentation material and all user activity associated with this presentation material, through the use of a three-tiered system. Each tier represents one of three “levels” of interest in the item offered for sale. These three levels of activity are characterized by virtual actions (referring to the fact that it occurs on an Internet website) performed by a prospective buyer that are analogous to the physical actions that would be performed by a potential buyer in his pursuit to purchase an item in a non-Internet environment.

Thus, using the Real Estate industry as an illustrative example, the three levels constituting the Tracking Function would be:

Level 1. The “Virtual Drive-By”—indicating that this prospective buyer has at least superficial interest in the property. This feature consists of a page, or electronic brochure (“E-Brochure”), that appears when a user selects a specific property from a list of categorized properties. The electronic brochure is analogous to the printed flyer/brochure that is often made available for a real property or other item for sale. Under normal circumstances, the seller would typically have to “drive by” the physical location of the property or item for sale and pick up this brochure. For example, quite often, there is a brochure box located on the sale sign of a real property. In addition, vehicles will sometimes have a brochure under the windshield wiper that prospective buyers may pick up to gather more information. The electronic brochure shows:

a. A brief description of property, including price, location, dimensions, and basic features;

b. Still frame image(s) of the property, possibly including multiple views, either ground or aerial; and

c. Agent contact information.

Level 2. The “Virtual Showing”—typically indicating that this prospective buyer has a deeper, or more significant, interest in the specific property. This feature is a hypertext link labeled “Virtual Showing” that, once selected, displays at least one of the following:

a. A slide show of various images (generally ranging in number from 1 to 24).

b. 360° “Virtual Tours” (photos created with special software using images from a “fisheye” lens camera); and

c. Mini movies or multimedia presentations.

Level 3. The “Virual Meeting”—indicating that the prospect has serious interest in the specific property. The chosen property appeals to the prospect sufficiently enough to prompt him/her to surrender anonymity (by giving out name and email address). This feature gives the prospect all information necessary to negotiate and conclude a deal. The information provided to the prospect now includes such details as:

a. Large color images (possibly expanded versions, i.e.—full screen/full printed page, of smaller images present on the “Virtual Drive-by”/electronic brochure)

b. Title Information;

c. Zoning/Municipality Information;

d. Site plans;

d. CAD drawings;

e. Drawings/renderings, in full color; and

f. Topographical maps

g. Extended streaming multimedia footage and/or narrative descriptions as technology allows

It is important to note that it is expected that the technology used to display information, along with the nature and format of the information permitted by this technology, will be continuously evolving and improving. However, the process of categorizing this information, manipulating it, and associating levels of prospective buyer awareness and interest with it, will universally apply as these evolutions take place. For example, current technology provides the ability to display “Virtual Tours” as either an array of “flat” photo images or as 360° images. In the future, it is presumed that increasingly complex and perhaps more interactive types of imagery will be available. However, the process of defining this imagery and subsequent viewer responses associated with it, as defined throughout the description of I-CAST, will remain applicable.

Additionally, each category will be titled, described, and presented using vernacular that is appropriate to the subject item for sale. Thus, while the use of the term “Virual Drive-by” to describe Level 1 is appropriate for the presentation of a real property, it would not be applicable to the sale of a music album. Hence, using the sale of a music album as an example, Level 1 may be described as “Check Out This Artist!” or with language similar thereto.

The Presentation/Overview Component:

In the near future, we expect that the complete I-CAST module will consist of four levels of activity that will be logged and reported to sellers in an effort to help ascertain the level of interest in the particular item made available on a database-driven web page. The fourth item will actually fall second in line among the existing levels used to measure the interest displayed by a prospective buyer. The VIP overview as described below will be situated between the “Virtual Drive-by” and “Virtual Showing”. This module will not be added until the technology and bandwidth for delivering the information is more readily available to the average consumer visiting a database-driven website that utilizes the I-CAST system. For example, this feature is predicated upon the existence of technology that allows users to download and view video images in a short and practical timeframe. Additionally, it will be necessary for the typical multimedia production vendor to be able to manufacture short, quality multimedia presentations in a time and cost effective manner. Upon addition of this fourth feature, the I-CAST Reports will be revised to include the statistical reporting of associated information generated in relation to the other three existing levels herein described.

The overview component, to be known as “VIP Overview” for the sale of real estate or other high complexity and/or high (dollar) value items, allows the seller or seller's agent to add a personalized multimedia narrative to supplement and enhance the text, drawings, and pictures used to present an item being offered for sale to the public. This feature consists of a flashing hypertext link labeled “VIP Overview” that, once selected, displays a short streaming multimedia presentation typically narrated by the seller, seller's agent, or sometimes a professional voice. The feature is displayed on the electronic brochure, also known as the “Virtual Drive-by”, of each item offered for sale. The overview function enables the seller or seller's agent to personally explain the subtleties and nuances of a deal or item for sale. It may also provide a quick overview/example of the documentation or visual aids available within the “Virtual Showing” or “Virtual Meeting” portion of the item presentation. This feature allows the seller or seller's agent to “pitch” the item for sale to the prospective buyer. Essentially, the “VIP Overview” is an individual, custom made “commercial” for each specific property or item. This feature will be a useful tool to help entice a prospective buyer to further investigate the additional information available in the subsequent interest level categories (i.e.—the “Virtual Showing” and “Virtual Meeting”).

The Accountability Function Components:

The “Accountability” portion of the I-CAST system tracks and records all user activity on the website (also referred to as the “Tracking Function”); and uses this recorded information to create activity reports, called “I-CAST Reports” (also referred to as the “Reporting Function”).

The “Reporting Function”, or I-CAST Report, generates and provides all information in “real time”—i.e., immediately whenever it actually occurs, or is required or desired; and is continually updated and available. The system can also be set up, if desired, to email the seller, and any other chosen party, on a regular periodic schedule or on an asneeded/requested basis.

The “Reporting Function” generates statistics (typically in the form of ratios) using the information gathered and measured by the website. Again using Real Estate property as an illustrative example, these generated statistics would include:

1. The ratio of “Virtual Showing” to “Virtual Drive-by”—which reveals the percentage of people who participated in a “Virtual Showing” after the initial “Virtual Drive-By”.

2. The ratio of “Virtual Meeting” to “Virtual Showing”—which reveals the percentage of people who participated in a “Virtual Meeting” after seeing the “Virtual Showing”.

3. The ratio of “Virtual Meeting” to “Virtual Drive-by”—which reveals the percentage of people who progressed all the way to a “Virtual Meeting” from the initial “Virtual Drive By”.

The Casting Service Component:

The “Casting” service portion of the I-CAST system is intended to obtain the maximum exposure of an item being offered for sale to the public. The Casting service component of the system and method provides two different internal functions, the “Broadcasting Function” and the “Referral Function”. The Casting service component, however, provides merely one element of a larger marketing effort. Casting service is merely one of a wide variety of different techniques which can be used to generate traffic to a particular Internet website featuring comprehensive information on unique items (currently, due to technological limitations, only those of a complex, and/or high (dollar) value nature) offered for sale.

The “Broadcasting Function”

The “Broadcasting Function” allows information to be sent out on either an automated or at will basis. The automated broadcasting function will send out information on a predetermined interval (i.e.—once a day, once a week, etc.). The system is intended to send a different item per each interval, such that the broadcast email recipient does not receive multiple emails presenting the same item for sale.

The “Broadcasting Function” is comprised of a broadcast e-mailing mechanism and a collection of email listservs that have been identified by the user of the I-CAST system. A listserv consists of a group of people with similar interests, or some other commonality, that have requested that they receive information (in this case, on items for sale associated with their specific industry or interest) as it becomes available to that list. This categorization allows certain groups of individuals to be treated as one entity. Rather than selecting individual email addresses for which to send information, the I-CAST user simply chooses a particular broadcast list, or group of industry related or specific broadcast lists, for broadcasting purposes.

A database will contain all broadcast lists (also known as “listservs”), identified by the user, as well as allow the user to add to or modify the collection of broadcast lists. Furthermore, individual users may also create their own unique, personal broadcast lists (i.e.based on personal or corporate contact lists, or community oriented lists such as a regional manufacturers directory).

The “Listserv Signup Function” provides a means for sellers or seller's agents to access the listservs available in order broadcast information to them. Sellers or seller's agents will login to their “Administration (or “Admin”) Area” and be able to select from a list of listservs to subscribe to using their email address. The listservs that they subscribe to will be recorded in a database table. They will then be able to broadcast email to the listservs that they are subscribed to, a text message or an electronic brochure (“E-brochure”), of an item for sale. They will be able to select from a list of their items for sale (i.e.—properties) and send the item's information (E-brochure), via a hyperlink to this specific item's URL on the database website, to one or more of the listservs they are subscribed to. In addition to this function, the seller or seller's agent will be able to “queue up” an item for sale in the “Broadcast Function” upon entry or edit of the product for sale (i.e.—a property). When a user wishes to broadcast an item, these email lists are then uploaded from the user to the I-CAST server, where they are maintained and stored.

Each item, or E-brochure, to be sent out is input into the system manually or selected from an existing inventory list. One alternative approach to the use of the “Administration Area” described above is to have the seller or seller's agent fill out an “I-CAST Submittal Form” and give this form to a third party (such as an “I-CAST Staff Member”) to be keyed into the “Administration Area”. In the case of a real estate office that utilizes the I-CAST system, the seller's agent may check off, on an “I-CAST Submittal Form”, the specific email lists to receive a particular property's E-brochure. Broadcast email information is then input to the system by an I-CAST staff person.

The “Administration (or Admin) Area” allows for both the input, and subsequent manipulation, of broadcast data through the use of four user interface screens.

1. “Input Item/Choose Broadcast List” screen—A user inputs the request into the system, possibly based on a submittal form, by utilizing this screen. The screen is comprised of various information fields allowing the user to input specific data associated with a future broadcast email. These fields include, but are not limited to, the broadcast email list (listserv), Item/Property ID Number (or other necessary or requested information regarding the item for sale), Send Date, Subject Line (allowing user to include a short heading to the broadcast email), and a Message box (Optional—user may include a short commentary). In addition, the screen contains a “Submit” button that the user selects with a computer mouse in order to send the item.

2. “Pending Broadcast Email List” screen—The I-CAST system automatically places new item postings on a “Tending Broadcast Email List”, accessible via the “Pending Broadcast Email List” screen, in the sequence that the items are entered into the system. This automated feature permits no more than one item to be broadcast to a particular listserv per specified period (usually per day). The system is specifically designed to prevent “spamming”, or sending an intolerable number of items, to the recipient listserv. Once an item is entered into the Broadcasting Function, the I-CAST staff can, if necessary, alter which day an item will be broadcast by either inputting a new broadcast date or by manually overriding the chronological sequence in which the item was entered. The system automatically shifts the prior existing sequence of pending items either backward or forward one time interval (most likely one day), according to where the newly adjusted item is placed. If, by chance, an override creates a conflict in which more that one item will be sent at a particular time interval, the system will alert the user of the scheduling conflict and request that the user input a new broadcast time for the item in question.

This screen is comprised of a list of items for sale (more specifically, the items' respective E-brochures) that are waiting to be sent out. Each item may be sent via either the automated function or by manually selecting a “Send” button associated with each item. Furthermore, each listed item has a series of fields that contain either information about the pending broadcast item or a selectable means of manipulating the related data. Descriptive information fields include, but are not limited to, “List Name” (showing which listserv the item is broadcast to), “Item/Property ID Number”, “Item/Property Type”, “Date Entered”, “Date To Send”, “Subject”, and “Message”. Fields allowing information to be manipulated include, but are not limited to, “Edit” and “Delete”. Both the “Edit” and “Delete” fields use hypertext and are actuated by selecting the each respective word with the computer mouse. By selecting the “Edit” function, the user is brought back to the “Input Item/Choose Broadcast List” screen where changes can be made. Selecting the “Delete” function removes the broadcast item from the Pending Broadcast List.

3. “Historical Broadcast Email Archive” screen—this screen is comprised of a detailed log of all completed broadcast emails in reverse chronological order (most recent broadcast emails shown at the top of the screen). Each history item includes, but is not limited to, information categories such as “Sender”, “Recipient” (usually a listserv), “Item/Property ID Number” or hyperlink associated with the item for sale, “Item/Property Type”, “Date Entered”, “Date Sent”, “Subject”, and “Message”. Additionally, there is a “re-queue” option box that may be checked if the user would like the item to be added to the Pending Broadcast Email List sequence. A user may reference a particular broadcast email, or group of broadcast emails, using any or all of the item information categories. This historical archive facilitates review, documentation, and reporting of the broadcast information to the seller or seller's agent.

4. “Broadcast List Contror” screen—this screen allows the user to add new broadcast email lists (listservs) to the database. This screen is comprised of a list of all existing broadcast email lists (listservs) available on the system. This master list may be broken down into categories and subcategories as needed. The list contains columns, with associated headings, that apply to each item in the master list. These columns include, but are not limited to, “Edit”, “List Name”, “List Email”, “Trom Email” (who the item is shown to be sent from), “Type” (category or heading that the list falls under). The screen also contains a hypertext link labeled “Add New Broadcast List”, allowing the user to add an additional listserv to the master list.

The “Broadcasting Function” is designed to periodically (per chosen timeframe) send an email message to certain email address(es) or a pre-selected list(s) of email addresses. The recipients of the broadcast will receive an e-mail transmission featuring a single item for sale. The email will contain basic information from the user's web site—such as thumbnail photos, a short paragraph description and the price. The e-mail will direct the recipient via hypertext link to the website to receive additional and more detailed information.

The broadcast emails received will appear to originate from either the seller or seller's agent (as the case may be) via a respective email address. This allows a seller or seller's agent to issue timely and informed replies to questions or comments about the item for sale as soon as broadcast email recipient poses them.

The “Listserv Signup Function”

The “Listserv Signup Function” is actually an integral part of the “Broadcasting Function”. It is intended to facilitate enrollment (or unenrollment) to the “email recipient, or broadcast, lists” (also known as “listservs”) available. Specifically, this function will provide a means for those who wish to broadcast information (i.e.—sellers and seller's agents) and those who wish to receive information (i.e.—prospective buyer or any other party that is interested) to enroll (or unenroll) to a particular listserv.

This feature will be available via a web-based interface. The Listserv Signup Function may be accessible through an I-CAST website or a specific user's database-driven website that utilizes the I-CAST system.

The “Referral Function”

The “Referral Function”, also known as “Email-A-Friend”, is designed to allow the website user to send information (a web page(s) or a hyperlink to a web page(s)) concerning an item for sale to another person or potential customer. This function may also be referred to as “Email This Property”, or “Email This Item”, as deemed appropriate to the specific item or situation for which it is used. This feature also allows an I-CAST system based company to send information on a sale item in response to direct phone/fax/email inquiries that are the result of other forms of marketing (i.e.—print, radio, television). These transferred web pages act as a paperless electronic brochure that describes and details the item being offered for sale.

The “Referral Function” is comprised of a digital “button” labeled “Email-A-Friend” that typically appears on the screen of each product's detailed web page associated with an item for sale on an existing website. Users may activate the “button” at will by pointing to the button with a computer mouse cursor, and then pressing the left mouse button to select the object. This button activates the “Email-A-Friend” feature.

Once the “Email-A-Friend” feature is activated, a “popup window” appears. The “popup window” is composed of a box approximately ¼ to ½ the size of the full screen size. The “popup window” contains labeled text fields allowing the user to type information. Required Fields (those requiring information to be entered in order for the email to be sent) include those for “Sender Email Address” and “Recipient Email Address”, or employs language similar thereto. Non-required Fields include a multiple line “Comments” Field that allows the sending user to include any text information or comments desired with regards to the web page being sent. At the bottom of the window is a “Send” button that, upon selection by user, transfers the web page contents (or a hyperlink to the web page) to another user. The window then disappears from the screen automatically.

The Administrative Service Component

The Administrative service of the I-CAST system and method satisfies multiple purposes. Merely representative of these administrative purposes are the following:

1. Providing a means of collecting, compiling, organizing and if desired, broadcast emailing, all information and documentation necessary to complete and close a transaction.

2. Digitally controlling and coordinating, through an Internet web site, all closing administrative activities associated with consummating a deal between a buyer and a seller for the sale of an item, specifically one that is unique, complex, or high (dollar) value in nature.

3. Informing all parties involved, through an Internet web site, about all closing administrative activities associated with the consummation of a sale of an item, specifically one that is unique, complex, or high (dollar) value in nature, between a buyer and a seller.

These features are particularly valuable in complex transactions, such as those occurring in the commercial real estate field, in which numerous professional service providers, brokers, and parties to the transaction, who are possibly in dispersed locations, must communicate and coordinate their actions in order to complete the closing of a deal.

The Administrative service component of the I-CAST system will employ a database of all persons and institutions involved in or necessary to the complete exchange of ownership of a particular item for sale. This database includes entities such as:

1. Vendors (such as title companies, lending institutions, contractors, insurance carriers, etc.); and

2. Municipalities and government agencies

3. Specialized professionals and licensed service providers

Each member or entity involved in the transaction in the database will have a check box associated with it. Users of the database may select, or “check off”, specific members that are to automatically receive a certain document or correspondence via email. Tiered access levels may be associated with this feature, such that certain members or entities may only be entitled to view items of a particular nature (i.e.—information specific to their portion of the transaction, or information of either a privileged or non-privileged nature as the case may be). In addition, each respective member's name will have an appropriate task check list associated with it, allowing that party (or an escrow agent or other party that coordinates the transaction activities) to mark the completion of each particular task pertaining to his/her specific line of duty. Additionally, all members will have access to a scrolling comment field that allows them to make remarks pertinent to the transaction or to the unique circumstances encountered while completing a task. Thus, the unforeseen, yet common obstacles that occur in completing a complex transaction are documented for all members to review. All tasks completed or comments made will include a date and time “stamp” designation, hence recording when the activity took place. Therefore, important information is made available that might not otherwise be communicated to any, let alone all, parties involved.

The Administrative service component of the I-CAST system, when used in the Real Estate industry, is often referred to as “Closing Administration”. This service will handle all matters and contingencies related to closing real estate transactions or deals. Information is accessible to all parties in the transaction (based on their designated level of access) so that they will receive any indication of a complication or delay relative to the professional responsibilities or tasks that are necessary to completion of the closing. This feature ensures accountability by all parties involved, and thus helps relieve any one party of a liability due to the failure of another party to perform as agreed upon. Specifically, this feature helps relieve the seller, or seller's agent, from the burden of “babysitting” all parties involved in the transaction. Particularly, those who regularly, for some reason or another, do not complete their required tasks in a timely manner. Furthermore, this feature allows any or all parties to clarify misunderstandings and avoid consequent disputes. The Administrative service component is of great value not only for the sale of real estate, but also for the sale of all other unique, complex, and/or high (dollar) value items offered to the purchasing public.

What is claimed is:

1. A system or method known as I-CAST, or Internet Casting Accountability Sales Technology, wherein all components subsequently described herein are an integral part of said system.

2. A system or method that categorizes presentation material regarding an item for sale (most appropriately for unique, complex, and/or high value items such as real estate, capital equipment, heavy machinery, commercial or passenger vehicles, recreational vehicles, watercraft, and aircraft) through the use of a three tiered system, with each tier representing one of three “levels” of interest in, or activity associated with, the item offered for sale.

3. A system and method according to claim 2, wherein the spectrum of prospective purchaser interest (i.e.—not interested to extremely interested) is divided into categories of interest based on varying levels of intensity.

4. A system or method according to claim 2, wherein the three levels of activity are characterized by virtual actions (referring to the fact that it occurs on an Internet website) performed by a prospective buyer that are analogous to the physical actions that would be performed by a potential buyer in his/her pursuit to purchase an item in a non-Internet environment.

5. A system and method according to claim 4, when applied to the field of real estate sales, that is composed of levels labeled “virtual drive-by”, “virtual showing”, and “virtual meeting”.

6. A system and method according to claim 4, wherein an electronic brochure (or “E-Brochure”), referred to as a “virtual drive-by” in the field of real estate sales, acts as a main information presentation page for the item offered for sale.

7. A system or method according to claim 4, wherein an electronic brochure, or “Virtual Drive-By”, shows
a. A brief description of the property, including price, location, dimensions, and basic features
b. Still frame image(s) of the property, possible including multiple views, wither ground or aerial; and
c. Agent contact information.

8. A system or method according to claim 4, wherein a “Virtual Showing” is accessible via a selectable hyperlink or icon and, once selected, displays at least one of the following:
a. A slide show of various images (generally ranging in number from 1 to 24).
b. 360° “Virtual Tours” (photos created with special software using images from a “fisheye” lens camera); and
c. Other forms of media as technology improves.

9. A system or method according to claim 4, wherein a “Virtual Meeting” is accessible via a selectable hyperlink or icon and, once selected, indicates that a prospective has serious interest in a specific property, or at least sufficient enough to prompt him/her to surrender anonymity (by giving out name and email address).

10. A system or method according to claim 9, wherein a “Virtual Meeting” gives the prospect all information necessary to negotiate and conclude a deal, including but not limited to details such as:
a. Large color images (possibly expanded versions, i.e.—full screen/full printed page, of smaller images present on the “Virtual Drive-by”/electronic brochure)
b. Title Information;
c. Zoning/Municipality Information;
d. Site plans;
e. CAD drawings;
f. Drawings/renderings, in full color; and
g. Topographical maps
h. Extended streaming multimedia footage and/or narrative descriptions as technology allows

11. A system or method according to claim 6, referred to as the “Virtual Salesperson”, wherein the seller or seller's agent to add a short, personalized, multimedia (audio/video) narrative, or essentially a “sales pitch” or custom made commercial, to supplement and enhance the text, drawings, and pictures used to present an item being offered for sale.

12. A system or method according to claim 11, wherein the “Virtual Salesperson” may be switched on or off as the prospective buyer desires, via a selectable hyperlink or icon displayed on the electronic brochure and that, once selected, displays a short streaming multimedia presentation typically narrated by the seller, seller's agent, or a hired voice, and hence explains the subtleties and nuances of an opportunity or item for sale.

13. A system and method, known as the “Reporting Function”, that tracks, assesses, and reports levels of consumer interest and response to internet marketing and sales efforts for items (most appropriately for unique, complex, and/or high value items such as real estate, capital equipment, heavy machinery, commercial or passenger vehicles, recreational vehicles, watercraft, and aircraft) offered for sale to the purchasing public via the internet.

14. A system and method according to claim 13, wherein non-digital person-to-person inquiries (via phone, fax, or personal request) about an item for sale and/or responses to all forms of advertising (i.e.—signage, print, radio, television, etc.) of said item are converted into digitally recorded events by emailing an E-Brochure to the person requesting information, thus enhancing a seller's awareness of the results of a marketing campaign relating to the item.

15. A system and method according to claim 13, wherein statistical reports, called I-CAST reports, are created and available in “real time” to describe and display the intensity of interest that is being generated for an item for sale.

16. A system and method according to claim 15, wherein the reporting mechanism may be programmed to email the seller, and any other chosen party, on a regular periodic schedule or on an as-needed/requested basis.

17. A system and method according to claim 15, wherein statistical reports are typically composed of ratios using the information gathered and measured by the website, such that reporting for the real estate industry would include:
a. The ratio of “Virtual Showing” to “Virtual Drive-by”—which reveals the percentage of people who participated in a “Virtual Showing” after the initial “Virtual Drive-By”.
b. The ratio of “Virtual Meeting” to “Virtual Showing”—which reveals the percentage of people who participated in a “Virtual Meeting” after seeing the “Virtual Showing”.
c. The ratio of “Virtual Meeting” to “Virtual Drive-by”—which reveals the percentage of people who progressed all the way to a “Virtual Meeting” from the initial “Virtual Drive By”.

18. A system and method, known as the “Broadcast Function”, that generates interest on an item offered for sale to the purchasing public via the internet, in order to track said interest.

19. A system or method, according to claim 18, that is comprised of a broadcast email system and a collection of email listservs that have been identified by the user of the system.

20. A system and method according to claim 18, wherein items for sale are sent out to an email listserv on an automated or at will basis.

21. A system and method according to claim 20, wherein the automated function sends out information at a predetermined interval (i.e.—once a day, once a week, etc.)

22. A database according to claim 16, which displays all broadcast lists (listservs) and that allows users to create or modify broadcast lists.

23. A system and method according to claim 22, wherein sellers or seller's agents will login to an “Administration Area” in order to access and manage the “Broadcast Function”.

24. A system and method according to claim 23, wherein a “Listserv Signup Function” in the “Administration Area” provides a means for sellers or seller's agents to select from a list of listservs to subscribe to using their email address, and to access said listservs in order to broadcast information to them be.

25. A system and method according to claim 24, wherein the seller or seller's agent uses a “Broadcast List Control” screen to add new broadcast email lists to the database.

26. A system and method according to claim 24, wherein the seller or seller's agent uses an “Input Item/Choose Broadcast List” screen to select listservs from the list of subscribed listservs in order to send product information (such as an electronic brochure, or “EBrochure”).

27. A system and method according to claim 23, wherein the seller or seller's agent uses an “Input Item/Choose Broadcast List” screen to select from a list of inventory for sale (i.e. properties) and to send product information, via a hyperlink to each specific item's URL on the database website, to one or more of the subscribed listservs.

28. A system and method according to claim 23, wherein the seller or seller's agent is able to “queue up” an item for sale on a “Pending Broadcast Email List” screen such that it is to sent out automatically at a specified time.

29. A system and method according to claim 27, wherein each item for sale is input into the system manually or selected from an existing inventory list.

30. A system and method according to claim 23, wherein a “Historical Broadcast Email Archive” screen displays a log of completed broadcast emails.

31. A system and method according to claim 24, wherein it is intended that email recipients (members of a broadcast email list, or “listserv”) are able to enroll, or unenroll, from a listserv as desired.

32. A system and method according to claim 6, wherein a “Referral Function”, also known as “Email-A-Friend” or the “Virtual Assistant”, is present on the E-Brochure in order to allow a website user to send information concerning an item for sale to another person or potential customer.

33. A system and method, referred to as the “Administrative Service Component”, wherein all aspects of a transaction involving an item for sale, particularly one that is unique, complex, or of high (dollar) value, are documented, organized, and tracked.

34. A system and method according to claim 33 that digitally controls and coordinates all closing administrative activities associated with consummating a deal between a buyer and seller, along with informing all parties involved.

35. A system and method according to claim 33, wherein tasks associated with completing the transaction of an item for sale are displayed in a checklist format that allows each party to the transaction to mark off items that are the respective responsibility of each said party.

36. A system and method according to claim 33, wherein parties to a transaction are allowed varying levels of access to transaction documents.

37. A system and method according to claim 33, wherein parties to a transaction are able to make comments in a scrolling comment field.

38. A system and method according to claim 33, wherein all tasks completed and comments offered are chronologically recorded via a date and time stamp associated with the specific time that the event occurred.

39. A system or method that utilizes an easy-to-use, tutorial, template format, in which the user is guided through an information gathering process on computer, in order to create a customized, multimedia presentation (specifically one that incorporates all the benefits and features of the present system described herein) that showcases an item offered for sale.

40. A system or method comprising a unique form of real estate income property, based on a consignment sales lot concept, wherein the property owner provides a high visibility location and the marketing benefits of the present system described herein, as an integral part of the sales/purchase experience, to individuals or entities offering items for sale to the purchasing public.

41. A system or method according to claim 40, wherein the property is divided into numbered storage locations (parking spaces, storage units, bins, shelves, etc.) and each item for sale has an identification number assigned to it in accordance with the numbered storage location.

42. A system or method according to claim 40, wherein the present system is incorporated into the consignment sales process via a computer kiosk format; one in which computer terminals on the property allow prospective purchasers to preview items for sale in detail on an internet website featuring the I-CAST system.
